(19) United States
(12) Patent Application Publication
(10) Pub. No.: US 2004/0238259 A1
(43) Pub. Date: Dec. 2, 2004

(54) Motor vehicle

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/843,392

(22) Filed: May 12, 2004

(30) Foreign Application Priority Data
May 30, 2003 (JP) 2003-155251

(51) Int. Cl. B62D 5/06

(52) U.S. Cl. 180/408

(57) ABSTRACT

A motor vehicle that runs along a designated running route includes a steering unit for rotating four wheels nearly at the right angle to steer the motor vehicle. The steering unit allows the motor vehicle to turn at the right angle at a square corner section without changing the posture of a vehicle body.

### CROSS-REFERENCE TO RELATED APPLICATIONS

This application is based upon and claims the benefit of priority from prior Japanese Patent Application No. 2003-155251, filed May 30, 2003, the entire contents of which are incorporated herein by reference.

### BACKGROUND OF THE INVENTION

1. Field of the Invention

The present invention relates to a motor vehicle configured to run along a given running route while steering automatically in response to an instruction using radio communication.

2. Description of the Related Art

Various motor vehicles such as carriages for carrying baggage and the like have conventionally been developed. Some motor vehicles have a front-wheel steering mechanism for steering two front wheels and a rear-wheel steering mechanism for steering two rear wheels.

For example, Jpn. Pat. Appln. KOKAI Publication No. 10-076976 proposes a motor vehicle (carriage) as described above. This motor vehicle includes a steering mechanism in which a front-wheel steering mechanism and a rear-wheel steering mechanism are coupled to each other through a rebellious mechanism.

The running direction of the motor vehicle proposed in the above Publication is limited to a forward or backward direction. The motor vehicle has the advantage of causing no difference in inner ring between front and rear wheels because the front and rear wheels are associated with each other. However, it always runs along an arc when it turns to the right or the left.

### BRIEF SUMMARY OF THE INVENTION

An object of the present invention is to provide a motor vehicle capable of turning to the right or the left at the right angle.

A motor vehicle that runs along a designated running route, comprises four wheels provided at four corners of a bottom of a vehicle body, a running driving unit which rotates the four wheels and moves the vehicle body, and a steering unit which rotates the four wheels in a horizontal direction to steer the motor vehicle.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic side view of a motor vehicle according to an embodiment of the present invention;

FIG. 2 is a schematic top view of the motor vehicle according to the embodiment of the present invention;

FIGS. 3A and 3B are illustrations of the operation of a steering device of the motor vehicle according to the embodiment of the present invention; and

FIG. 4 is an illustration of the operation of the motor vehicle according to the embodiment of the present invention.

### DETAILED DESCRIPTION OF THE INVENTION

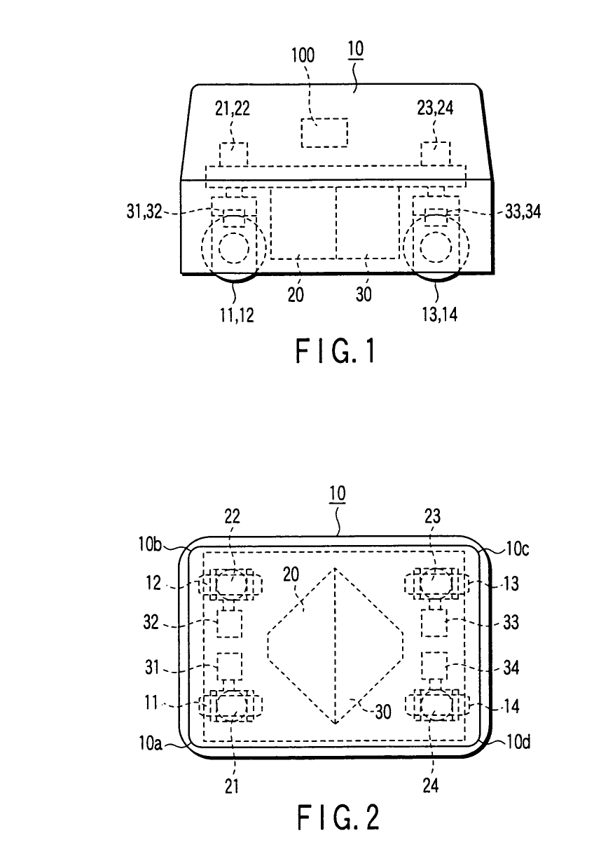

An embodiment of the present invention will now be described with reference to FIGS. 1 through 4.

(Configuration of Motor Vehicle)

A motor vehicle according to the embodiment of the present invention carries, e.g., a specimen-containing rack that is placed on the roof thereof. As shown in FIG. 1, the motor vehicle includes a radio communication unit and a control unit 100 that moves the vehicle along a designated running route in response to an instruction transmitted from a host computer by radio communication.

The motor vehicle can be configured to have a pair of carrying lanes that are formed in parallel on the roof thereof.

FIG. 1 is a side view of the motor vehicle and FIG. 2 is a top view thereof. The motor vehicle includes a vehicle body 10 having four wheels 11 to 14 at four corners 10a to 10d.

The motor vehicle also includes a running driving unit 20 for rotating the four wheels 11 to 14 and moving the vehicle body 10 and a steering unit 30 for rotating the four wheels 11 to 14 in the horizontal direction and steering the motor vehicle.

The control unit 100 controls the running driving unit 20 and steering unit 30 to cause the vehicle body 10 to run along a designated running route in response to an instruction sent from the host computer by radio communication.

The four wheels 11 and 14 have running motors 21 to 24, respectively. These motors rotate the wheels forward or backward. The running driving unit 20 drives the motors 21 to 24 to rotate the wheels 11 to 14 forward or backward and move the vehicle body 10 in a given direction.

The four wheels 11 to 14 have steering motors 31 to 34, respectively. These steering motors rotate the wheels in the horizontal direction within the range of the rotation angle of about 90°. The steering unit 30 includes a switching mechanism for driving the motors 31 to 34 to switch the direction of each of the wheels 11 to 14 within the range of the rotation angle of about 90°.

(Operation of Steering Unit 30)

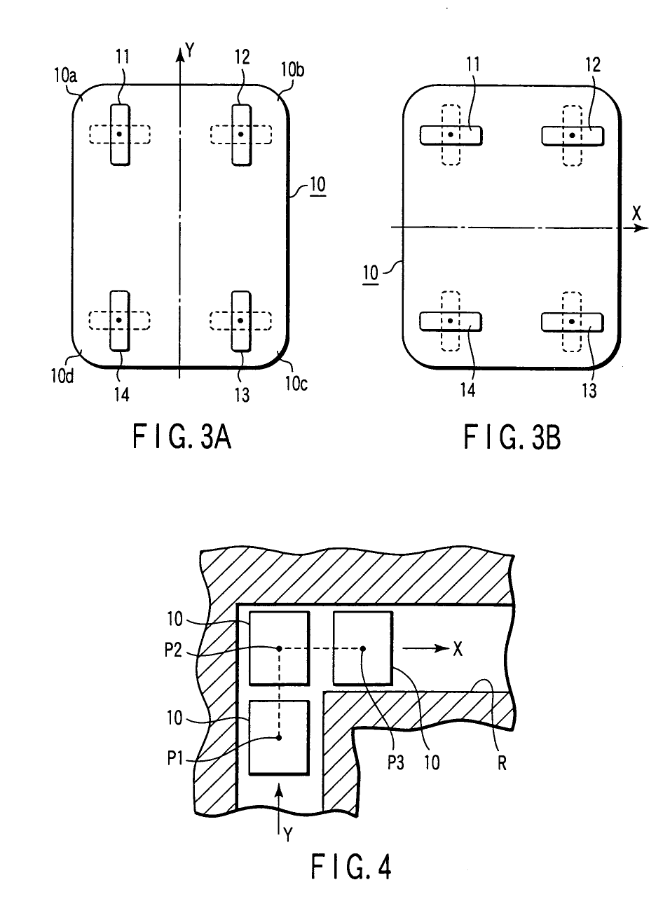

The steering unit 30 performs a steering operation to switch a running direction under the control of the control unit 100. The steering operation will be specifically described below with reference to FIGS. 3A and 3B.

When the vehicle body 10 runs in the first direction Y, the paired wheels 11 and 12 are used as front wheels and the paired wheels 13 and 14 opposed to the front wheels 11 and 12 are used as rear wheels, as illustrated in FIG. 3A.

When the vehicle body 10 runs in the second direction X that is perpendicular to the first direction Y, the paired wheels 12 and 13 are used as front wheels and the paired wheels 11 and 14 opposed to the front wheels 12 and 13 are used as rear wheels, as illustrated in FIG. 3B.

In other words, when the vehicle body 10 runs in the second direction X, the steering unit 30 drives the steering motors 31 to 34 to rotate each of the wheels 11 to 14 only 90°. If, therefore, the running driving unit 20 drives the motors 21 to 24 to rotate the four wheels 11 to 14 forward or backward, the vehicle body 10 runs in the second direction X.

(Operation of Motor Vehicle)

An operation of the motor vehicle according to the present embodiment will be described with reference to FIG. 4.

Assume here that the host computer moves the vehicle body 10 in the first direction Y and gives an instruction to switch a running direction to the second direction X at a square corner section (point P2) as shown in FIG. 4.

Upon receiving an instruction from the host computer, the control unit 100 of the motor vehicle controls the steering unit 30 to set the vehicle body 10 in the first direction Y.

The steering unit 30 performs a steering operation using the wheels 11 and 12 as front wheels and the wheels 13 and 14 as rear wheels as shown in FIG. 3A. The steering operation is done such that the vehicle body 10 does not stray from a designated running route.

The control unit 100 controls the running driving unit 20 to rotate the four wheels 11 to 14 forward, for example. The unit 20 drives the running motors 21 to 24 to rotate the wheels 11 to 14 forward. Thus, the vehicle body 10 moves straight from the first point P1 to the second point P2 as shown in FIG. 4.

When the control unit 100 reaches the second point P2 that is a square corner section, it controls the steering unit 30 to switch the running direction of the vehicle body 10 to the second direction X.

The steering unit 30 drives the steering motors 31 to 34 to rotate each of the wheels 11 to 14 only 90° as shown in FIG. 3B. In other words, a steering operation is carried out using the paired wheels 12 and 13 as front wheels and the paired wheels 11 and 14 opposed to the wheels 12 and 13 as rear wheels.

The control unit 100 controls the running driving unit 20 to rotate the four wheels 11 to 14 forward, for example. The unit 20 drives the running motors 21 to 24 to rotate the wheels 11 to 14 forward. Thus, the vehicle body 10 moves straight from the second point P2 to the third point P3 as shown in FIG. 4.

As described above, the motor vehicle according to the present embodiment runs while steering automatically along a running route designated by radio communication from the host computer. If the running route includes a very narrow path R having a square corner section as shown in FIG. 4, the vehicle body 10 does not run along any arc but can turn to the right or the left nearly at the right angle.

In other words, the motor vehicle according to the present embodiment can run a square corner section while keeping the posture of the vehicle body 10. Consequently, the motor vehicle can pass a square corner section of a very narrow path very smoothly.

In short, the motor vehicle according to the present embodiment includes the steering unit 30 for steering the vehicle by rotating each of the wheels 11 to 14 horizontally within the range of the angle of about 90°; therefore, the vehicle can turn at the right angle without changing the posture of the vehicle body 10 in accordance with a change in relationship between the front wheels and the rear wheels. Even though a running route includes a very narrow path having a square corner section, the motor vehicle can change its running direction to turn to the right or the left easily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A motor vehicle that runs along a designated running route, comprising:
four wheels provided at four corners of a bottom of a vehicle body;
a running driving unit which rotates the four wheels and moves the vehicle body; and
a steering unit which rotates the four wheels in a horizontal direction to steer the motor vehicle.

2. The motor vehicle according to claim 1, further comprising four steering motors which rotates the four wheels, respectively, in the horizontal direction, and
wherein the steering unit drives the steering motors to rotate the four wheels in the horizontal direction.

3. The motor vehicle according to claim 1, further comprising four running motors which rotates the four wheels forward or backward, and
wherein the running driving unit drives the running motors to rotate the four wheels forward or backward.

4. The motor vehicle according to claim 1, wherein the steering unit steers the motor vehicle using a pair of wheels as front wheels and using another pair of wheels opposed to the pair of wheels as rear wheels when the vehicle body moves in a first direction, and the steering unit steers the motor vehicle by rotating the wheels in a direction at a right angle using a pair of wheels as front wheels and using another pair of wheels opposed to the pair of wheels as rear wheels when the vehicle body runs in a second direction that is perpendicular to the first direction.

5. The motor vehicle according to claim 1, further comprising a control unit which controls the running driving unit and the steering unit to move the vehicle body along a designated running route in response to an instruction transmitted from an external device by radio communication.

6. The motor vehicle according to claim 1, wherein the vehicle body includes a mounting section on which a product to be carried is mounted, and the motor vehicle carries the product along a designated running route.
